(19) United States
(12) Patent Application Publication
(10) Pub. No.: US 2026/0132859 A1
(43) Pub. Date: May 14, 2026

(54) Check Valve With Secondary Flap

(71) Applicant: Red Valve Company, Inc., Pittsburgh, PA (US)

(72) Inventor: Michael J. Duer, Zelienople, PA (US)

(21) Appl. No.: 19/118,539

(22) PCT Filed: Oct. 9, 2023
(86) PCT No.: PCT/US2023/034754

§ 371 Date: Apr. 4, 2025

Related U.S. Application Data
(60) Provisional application No. 63/414,267, filed on Oct. 7, 2022.

(51) Int. Cl. F16K 15/14; F16K 15/16

(52) U.S. Cl. CPC F16K 15/147; F16K 15/1401; F16K 15/16

(57) ABSTRACT

A check valve includes a tubular sleeve having an upstream fluid inlet end region adapted to be affixed to an effluent conduit and a downstream fluid outlet region. The downstream fluid outlet region provides a flow-through passage for said fluids. The check valve further includes a disc affixed to at least one of a top wall and a pair of side walls of said sleeve. Said disc opens said valve in response to positive differential pressure within said valve. The check valve further includes a flap affixed to said disc. The disc defines an aperture forming a second opening for discharge of fluid in response to a second positive differential pressure within said valve. The second positive differential pressure is less than said first positive differential pressure, and said flap forms a seal against said aperture to prevent backflow when no differential pressure or negative differential pressure is present.

### CROSS REFERENCE TO RELATED APPLICATION

This application claims priority to U.S. Provisional Patent Application No. 63/414,267, filed Oct. 7, 2022, the disclosure of which is hereby incorporated by reference in its entirety.

### BACKGROUND OF THE INVENTION

### Field of the Invention

This invention generally relates to check valves, and, in particular, to tide gate valves having a secondary flap.

### Description of Related Art

A check valve is essentially a valve which allows fluid flow in only one direction through a conduit, while closing and preventing back or reverse flow, when back pressure builds up downstream of the valve to a level greater than the upstream fluid pressure head.

One example where the fluid backflow problem is especially acute occurs where such valves are used to handle storm sewer effluent. Virtually all municipalities near waterways have storm sewer pipes which empty into the waterways. When there is a storm, storm water from the streets runs into these sewer pipes and flows into the waterways. When the tide is in, or river level is high, these sewer pipes back fill with the water from the waterway. This leaves no, or reduced storage capacity in the sewer pipes. In the event there is a large cloudburst or storm during the time that the tide is in, all or a portion of the storm water cannot get in the sewer because the sewer pipes are at least partially filled. This causes street flooding.

Further, sewage treatment plants are often located at sea level and/or the lowest point possible of a municipality. They discharge a large quantity of water after treatment of sewage. Where such treatment plants discharge into a body of salt water, positive shut off is mandatory to prevent salt water intrusion. Salt water intrusion is the backflowing of salt water into the plant. Salt water intrusion must be prevented because salt water will destroy the ongoing biological treatment of sewage, forcing the plant to discharge raw sewage into the waterways, which is a situation that must be avoided.

The cost to water treatment facilities to correct the problems created by a malfunctioning check valve can be enormous. Prior art metal check valves have a tendency to have higher head loss pressures and malfunction due to rust clogging hinges associated with such valves. Prior art rubber valves suffer from the higher head loss pressure limitations described above.

Another example where the fluid backflow problem is especially acute is where the check valves are used in chemical plants or municipal waste treatment plants. In such applications, it is desired to permit waste water or treatment chemicals to enter a reaction vessel or pond from a storage container without permitting the contents of the reaction vessel to backflow into a storage container as the chemical reactions proceed.

To address the previously described problems, various types of check valves have been developed. One type of check valve that has been developed to counter these problems is known as a tide gate type check valve. An example of a tide gate type check valve is described in U.S. Pat. No. 5,769,125. However, while the check valve described in U.S. Pat. No. 5,769,125 addresses the previously described backflow problems, the check valve requires a finite minimum amount of upstream pressure greater than the downstream pressure before the valve will open. For example, it may require 13 inches of positive differential pressure before a 12 inch diameter valve will open. At this pressure, the valve opens abruptly from fully closed to partially open, commonly referred to as snapping open. In many applications, this is undesirable.

Thus, it is desirable to provide an improved tide gate check valve that requires a lower amount of positive differential pressure to open. It is also desirable to provide a tide gate check valve that has a second opening mechanism for low flow or low pressure conditions.

### SUMMARY OF THE INVENTION

The present invention is directed to a check valve that includes a tubular sleeve bounding a longitudinally-extending flow-through passage for fluids, said sleeve having an upstream fluid inlet end region adapted to be affixed to an effluent conduit and a downstream fluid outlet region. The downstream fluid outlet region of said sleeve is integrally formed with a top wall, a pair of side walls, and a bill, and the downstream fluid outlet region of said sleeve provides a flow-through passage for said fluids. The check valve further includes a disc affixed along a first portion of its periphery to a flexible member, said flexible member affixed to and interposed between said disc and at least one of said top wall and said pair of side walls of said sleeve. A second portion of the periphery of said disc opposite said first portion is affixed to said bill of said sleeve, and said disc opens said valve in response to positive differential pressure within said valve. The bill is integrally formed with said side walls of said sleeve, said bill being formed of a flexible material, said bill forming a first opening for discharge of fluid in response to a first positive differential pressure within said valve from said fluid, and said bill forming a seal to prevent backflow of said fluid through said valve when no differential pressure or negative differential pressure is present. The check valve further includes a flap affixed to said disc via a flexible hinge, said disc defining an aperture forming a second opening for discharge of fluid in response to a second positive differential pressure within said valve from said fluid. The second positive differential pressure is less than said first positive differential pressure, and said flap forms a seal against said aperture to prevent backflow of said fluid through said valve when no differential pressure or negative differential pressure is present.

In some embodiments, the flap and the flexible hinge are integrally formed with the disc.

In some embodiments, the flap is vulcanized to the disc.

In some embodiments, at least one of the disc and the flap include a sealing structure forming a seal between the disc and the flap.

In some embodiments, the sealing structure includes a beveled edge on at least a portion of the flap and a beveled edge on a portion of the disc corresponding to the beveled edge on the portion of the flap. The beveled edge on the portion of the disc tapers such that the aperture is larger on the side of the disc adjacent to the fluid outlet region and smaller on the side of the disc adjacent to the fluid inlet region, such that the flap is prohibited from passing through the aperture.

In some embodiments, the sealing structure comprises a material softer than the material of a surrounding region of at least one of said flap and said disc. The softer material is adapted to deform to create a fluid-tight seal.

In some embodiments, a perimeter of said flap is larger than a perimeter of said aperture such that said flap is prohibited from passing through said aperture.

In some embodiments, said sleeve, said flexible member, said disc and said bill are each formed of one or more plies of an elastomeric material.

The present invention is directed to a check valve assembly that includes a check valve as described above, and a tubular body. The check valve is at least partially integrally formed within the tubular body.

In some embodiments, at least one of an upstream region of the tubular body and a downstream region of the tubular body is affixed to an interior portion of a conduit.

The present invention also includes the following aspects.

Aspect 1: A check valve comprising:
(a) a tubular sleeve bounding a longitudinally-extending flow-through passage for fluids, said sleeve having an upstream fluid inlet end region adapted to be affixed to an effluent conduit and a downstream fluid outlet region;
(b) the downstream fluid outlet region of said sleeve being integrally formed with a top wall, a pair of side walls, and a bill, said downstream fluid outlet region of said sleeve providing a flow-through passage for said fluids;
(c) a disc affixed along a first portion of its periphery to a flexible member, said flexible member affixed to and interposed between said disc and at least one of said top wall and said pair of side walls of said sleeve, wherein a second portion of the periphery of said disc opposite said first portion is affixed to said bill of said sleeve, and wherein said disc opens said valve in response to a first positive differential pressure within said valve;
(d) the bill being integrally formed with said side walls of said sleeve, said bill being formed of a flexible material, said bill forming a first opening for discharge of fluid in response to the first positive differential pressure within said valve from said fluid, and said bill forming a seal to prevent backflow of said fluid through said valve when no differential pressure or negative differential pressure is present; and
(e) a flap affixed to said disc via a flexible hinge, said disc defining an aperture forming a second opening for discharge of fluid in response to a second positive differential pressure within said valve from said fluid, wherein said second positive differential pressure is less than said first positive differential pressure, and wherein said flap forms a seal against said aperture to prevent backflow of said fluid through said valve when no differential pressure or negative differential pressure is present.

Aspect 2: The check valve of aspect 1, wherein the flap and the flexible hinge are integrally formed with the disc.

Aspect 3: The check valve of aspects 1 or 2, wherein the flap is vulcanized to the disc.

Aspect 4: The check valve of aspect 1, wherein at least one of the disc and the flap include a sealing structure forming a seal between the disc and the flap.

Aspect 5: The check valve of aspect 4, wherein the sealing structure comprises: (a) a beveled edge on at least a portion of the flap; and (b) a beveled edge on a portion of the disc corresponding to the beveled edge on the portion of the flap, the beveled edge on the portion of the disc tapering such that the aperture is larger on the side of the disc adjacent to the fluid outlet region and smaller on the side of the disc adjacent to the fluid inlet region, such that the flap is prohibited from passing through the aperture.

Aspect 6: The check valve of aspect 4, wherein said sealing structure comprises a material softer than the material of a surrounding region of at least one of said flap and said disc, the softer material adapted to deform to create a fluid-tight seal.

Aspect 7: The check valve of aspect 3, wherein a perimeter of said flap is larger than a perimeter of said aperture such that said flap is prohibited from passing through said aperture.

Aspect 8: The check valve of any one of aspects 1-7, wherein said sleeve, said flexible member, said disc and said bill are each formed of one or more plies of an elastomeric material.

Aspect 9: A check valve assembly comprising: (a) a check valve according to any one of aspects 1-8; and (b) a tubular body, wherein the check valve is at least partially integrally formed within the tubular body.

Aspect 10: The assembly of aspect 9, wherein at least one of an upstream region of the tubular body and a downstream region of the tubular body is affixed to an interior portion of a conduit.

These and other features and characteristics of check valves, as well as the methods of operation and functions of the related elements of structures and the combination of parts and economies of manufacture, will become more apparent upon consideration of the following description and the appended claims with reference to the accompanying drawings, all of which form a part of this specification. It is to be expressly understood, however, that the drawings are for the purpose of illustration and description only.

### BRIEF DESCRIPTION OF THE DRAWINGS

FIG. 1a is a side cutaway view of a prior valve as described in U.S. Pat. No. 5,769,125.

FIG. 1b is an end view of the valve of FIG. 1a.

FIG. 1c is a top view of the valve of FIG. 1a.

FIG. 1d a perspective cutaway view of the valve of FIG. 1a.

FIG. 2a is a side cutaway view of a check valve according to the present invention enclosed in an integral tubular body with the entire assembly installed in a conduit.

FIG. 2b is a front view of the check valve and assembly of FIG. 2a.

FIG. 2c is a top cutaway view of the check valve and assembly of FIG. 2a.

FIG. 2d is a perspective cutaway view of the check valve and assembly of FIG. 2a.

FIG. 3 is a perspective cutaway view of a check valve according to the present invention that is rectangular in shape and which is installed in a concrete conduit.

FIG. 4a is a side cutaway view of another embodiment of a check valve according to the present invention enclosed in an integral tubular body with the entire assembly installed in a conduit.

FIG. 4b is a front view of the check valve and assembly of FIG. 4a.

FIG. 4c is a perspective cutaway view of the check valve and assembly of FIG. 4a.

FIG. 4d is a side cutaway view of the check valve and assembly of FIG. 4a shown in an opened position.

FIG. 4e is a front view of the check valve and assembly of FIG. 4a shown in an opened position.

FIG. 4f is a perspective cutaway view of the check valve and assembly of FIG. 4a in an opened position.

FIG. 5a is a side cutaway view of the check valve of FIG. 4a having an integral secondary flap.

FIG. 5b is a side cutaway view of the check valve of FIG. 5a with the secondary flap in an opened position.

FIG. 6a is a side cutaway view of the check valve of FIG. 4a having another embodiment of the secondary flap.

FIG. 6b is a side cutaway view of the check valve of FIG. 6a with the secondary flap in an opened position.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the Doctrine of Equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

Further, as used herein, the term “differential pressure” refers to the difference between the upstream and downstream pressures. A “positive differential pressure” refers to a condition where the upstream pressure is greater than the downstream pressure. This is also referred to as “headloss”. In addition, a “negative differential pressure” refers to a condition where the downstream pressure is greater than the upstream pressure. This is also referred to as “backpressure”. When the upstream and downstream pressures are equal to each other, the terms “no differential pressure” or “zero differential pressure” are used. This is also referred to as “no headloss” or “zero headloss”.

Referring now to the drawings, in which like reference numerals refer to like parts unless explicitly indicated to the contrary, the present invention is generally directed to check valves, and, more particularly, to tide gate valves having a secondary flap.

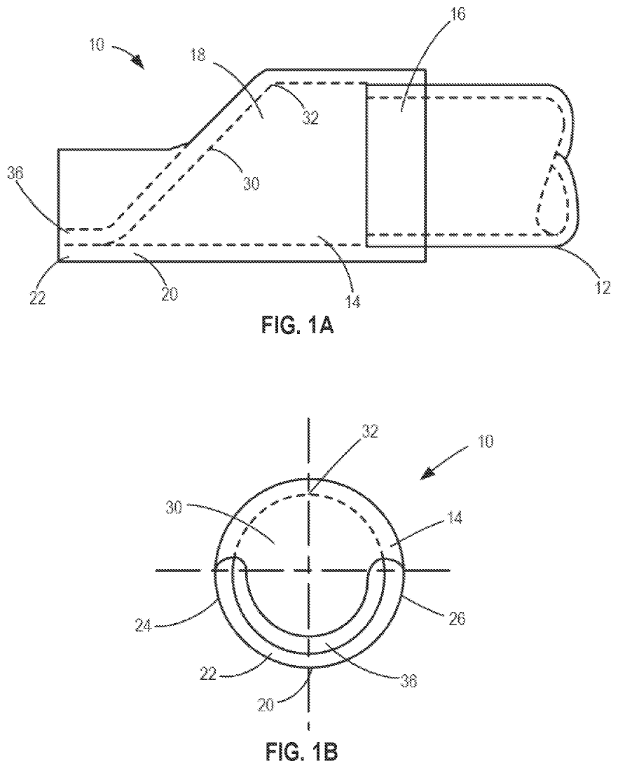

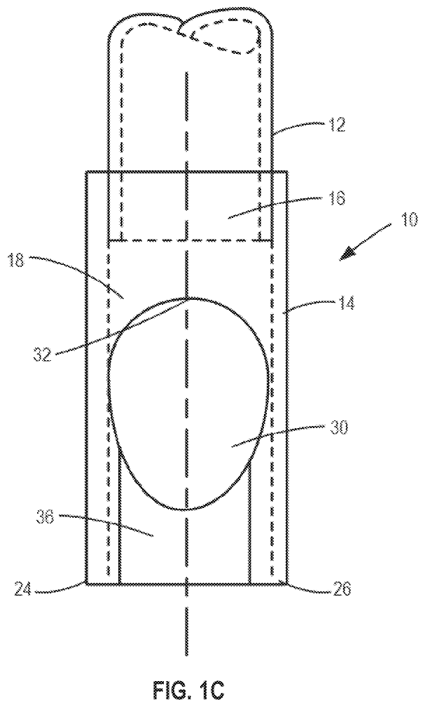

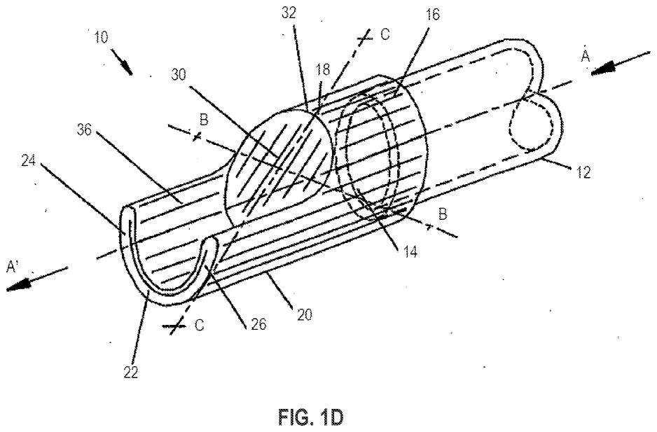

A known tide gate check valve, as described in U.S. Pat. No. 5,769,125, is illustrated in FIGS. 1a through 1d. Referring to FIGS. 1a through 1d, a check valve 10 is shown mounted at a discharge end of a conduit 12, from which fluids are discharged in the direction shown by the arrows A and A′. The conduit 12 may be a storm sewer, an industrial waste pipe, or any pipe which discharges an effluent into a river, creek, ocean, or analogous waterway, or a chemical reaction vessel or any vessel known in the art where it is desired to discharge a fluid while preventing backflow into the conduit 12.

The valve 10 generally comprises a sleeve 14, which bounds a longitudinally-extending flow-through passage for the effluent fluid which may be a gas, liquid, or slurry, such as raw sewage, storm rain water, sludge, chemical slurry, scum paper stock, tailings slurry, or any industrial waste. More specifically, the sleeve 14 has a generally tubular upstream fluid inlet region 16, which is either mounted on or within the discharge end of conduit 12.

Fluid inlet region 16 may be secured to the exterior of conduit 12 by any devices commonly known in the art such as bands, clamps, etc. Alternatively, fluid inlet region 16 may be affixed to the interior of conduit 12 by means known in the art. In still another embodiment, fluid inlet region 16 may include a flange which corresponds to a mating flange of conduit 12, and the two flanges, when mated, may be secured to each other by any means known in the art, such as bolts, nuts, and the like.

The sleeve 14 terminates at a second downstream end with a fluid outlet region 18. Fluid outlet region 18 is in turn integrally associated with a trough 20. Trough 20 is shown in FIGS. 1a, 1b, and 1c as semi-cylindrical in design, but it is to be understood that it could be designed as a U-shaped or V-shaped channel or the like. While a semi-cylindrically shaped trough 20 typically does not include a pair of clearly defined side walls and a clearly defined bottom wall, conceptually at least for the following discussion, it will be assumed that the semi-cylindrical shaped trough 20 is comprised of a bottom wall 22 and two side walls 24, 26 respectively.

Referring to FIGS. 1a through 1d, sleeve 14 and trough 20 are formed of materials having sufficient strength to support the weight and pressure of effluent flowing through valve 10. This material may take the form of one or more layers or plies of elastomeric material with or without reinforcing fabric. When formed of an elastomeric material, or elastomeric material with reinforcing fabric, the material and the number and thickness of layers or plies are selected based upon the weight of effluent that will be traveling through valve 10 so as to minimize sagging or distortion of sleeve 14 or trough 20. For most applications, a Shore A durometer of 65 to 95 will suffice.

Valve 10 further includes disc 30 as shown in FIGS. 1a through 1d. Disc 30 is composed of an elastomeric material and is affixed to fluid outlet region 18 of sleeve 14 via flexible member 32, which is in the nature of an elastomeric hinge. In one embodiment, the width of disc 30, as shown along line B-B in FIG. 1d, is coextensive with the distance between side walls 24, 26 of valve 10, thereby forming a seal against fluid from backflowing through valve 10 into conduit 12, with additional sealing being accomplished by bill 36. The length of disc 30 as measured along line C-C of FIG. 1d, and extending from flexible member 32 to bottom wall 22 of trough 20, must be longer than the interior diameter of sleeve 14. As shown in FIGS. 1a through 1d, this will prevent disc 30 from assuming a perpendicular or 90 degree angle with bottom wall 22, but will instead, ensure that disc 30 in a closed position assumes the inclined plane position as shown in FIGS. 1a through 1d. Such a position will prevent disc 30 from inverting and entering sleeve 14 and reduce the amount of positive differential pressure through sleeve 14 that is needed to open valve 10, and facilitate less than full flows of effluent through conduit 12.

Flexible member 32 may be any hinge known in the art, but is typically an elastomeric hinge comprised of one or more plies of an elastomeric material, or fabric reinforced elastomeric material. Flexible member 32 may be of “tire-cord” design, which is a polyester fabric that has considerable strength in one direction and is very flexible at right angles to the first direction. Further, the flexible member 32 may be made with a lower durometer rubber to provide greater flexibility in this area.

Other non-limiting features of a tide gate check valve that can be used with the present invention are disclosed in U.S. Pat. No. 5,769,125, which is incorporated by reference herein in its entirety.

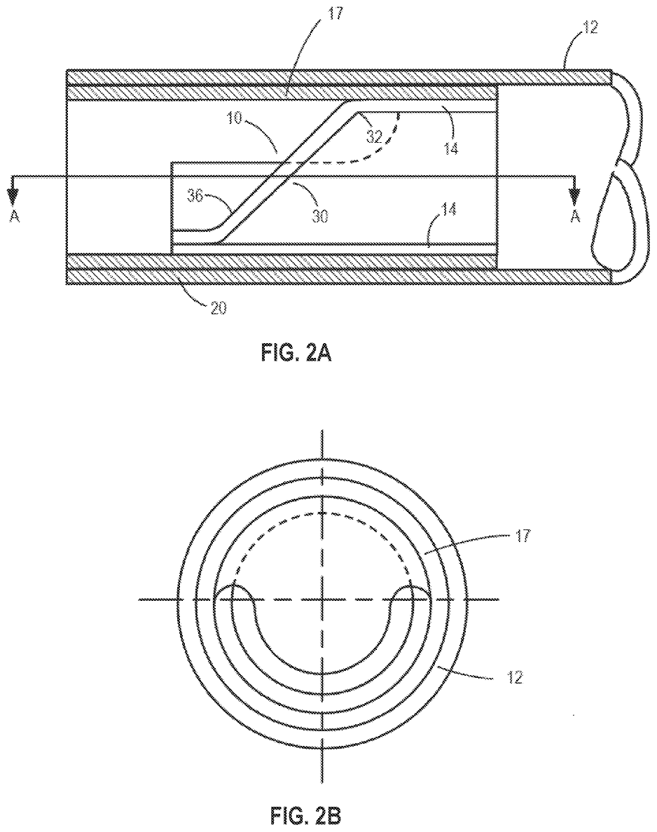

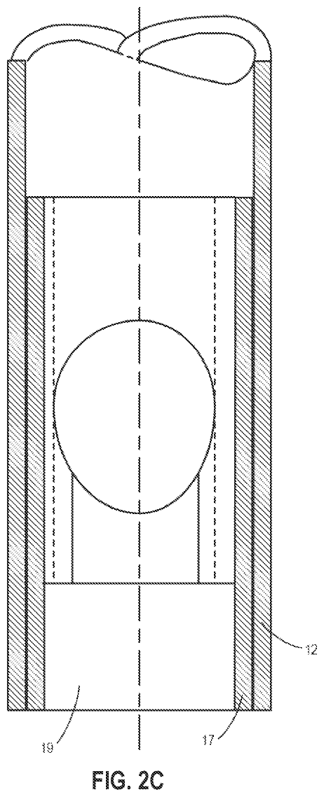

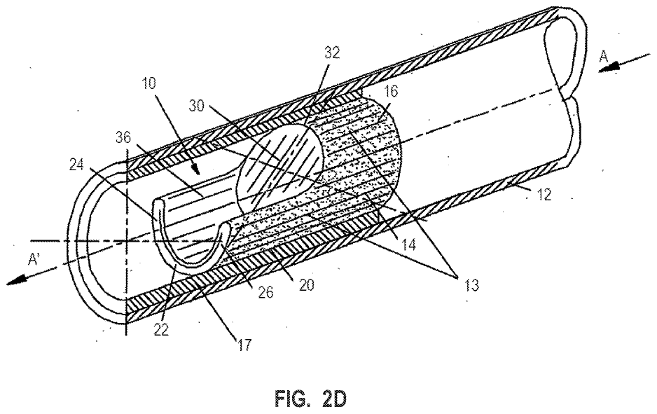

Referring to FIGS. 2a through 2d, the check valve 10 can be enclosed in an integral tubular body 17 which, in turn, is installed in a conduit 12 such as a pipe. As such, the present invention is also directed to a check valve assembly that includes any of the previously described check valves 10, an integral tubular body 17, and conduit 12. The check valve assembly provides a simple means to install a valve 10 and integral body 17 assembly inside a conduit 12 at the discharge end without the necessity of having access to the upstream end of the valve 10, which in the case of small valves (less than 18 inches) is virtually impossible to do, and in the case of larger valves is inconvenient.

As shown in FIG. 2c, the downstream region 19 of the tubular body 17 may be affixed to the interior of the conduit 12 by means known in the art, such as internal expanding clamps. Alternatively, the downstream region 19 may include a flange which corresponds to a mating flange on the conduit 12, and the two flanges, when mated, may be secured to each other by any means known in art, such as with bolts, nuts, and the like. In still another embodiment, fluid inlet region 16 may include a flange which corresponds to a mating flange affixed to the downstream end of conduit 12, and the two flanges, when mated, may be secured to each other by any means known in the art, such as bolts, nuts, and the like.

When the check valve 10 is integral with a tubular body 17, the entire lower portion of the check valve 10, below the plane of the horizontal centerline of the valve 10, is vulcanized to the tubular body 17. Further, the portions of the check valve 10, above the plane of the horizontal centerline of the valve 10 that are in contact with the tubular body 17 when the valve 10 is fully closed, are vulcanized together. These vulcanized regions 13 are shaded in FIG. 2d. As further shown in FIG. 2d, the bill 36 and disc 30 of the valve 10 are not vulcanized to the tubular body 17 and are free to move upward allowing the valve 10 to open and discharge flow. As such, the bill 36 and disc 30 of the check valve 10 are separated from the interior portions of the tubular body 17.

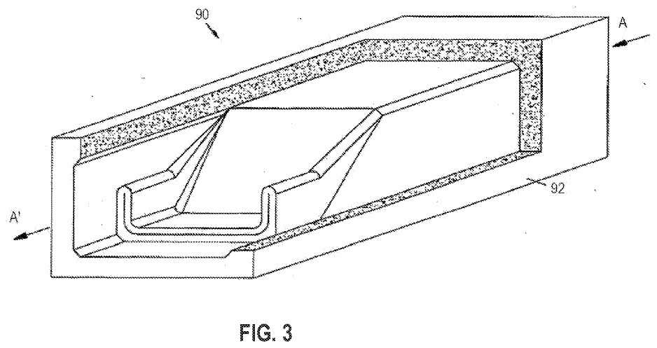

As previously described, the check valve 10 of the present invention can have a circular shape. Alternatively, in some embodiments, the check valve 10 is a different shape including, but not limited to, a rectangular, square, oval, or elliptical shape. For example, FIG. 3 illustrates a rectangular shaped check valve 90 having a rectangular disc 91 that is installed in a concrete conduit 92.

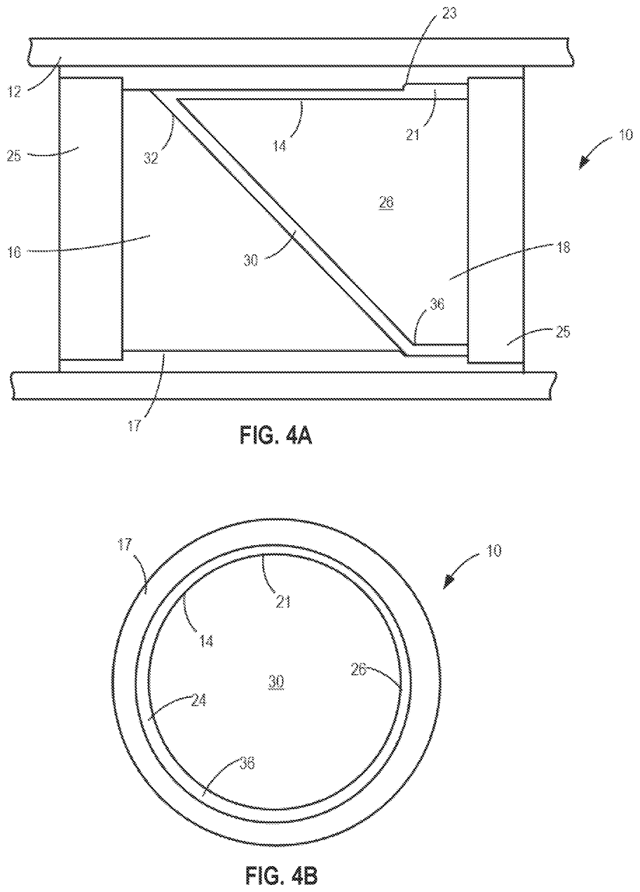

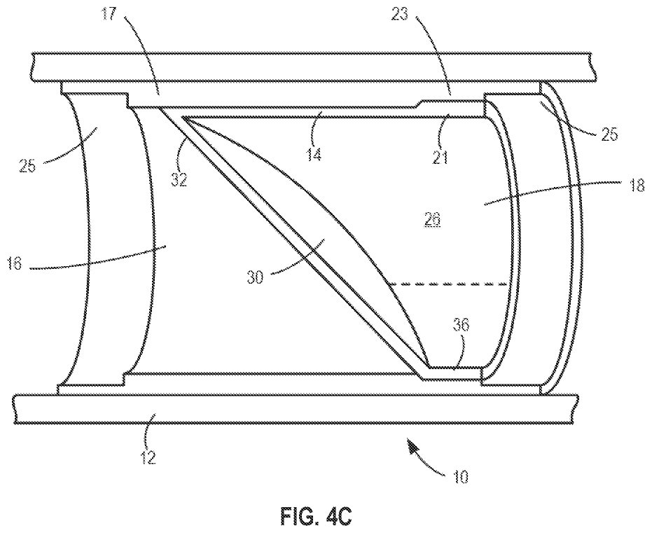

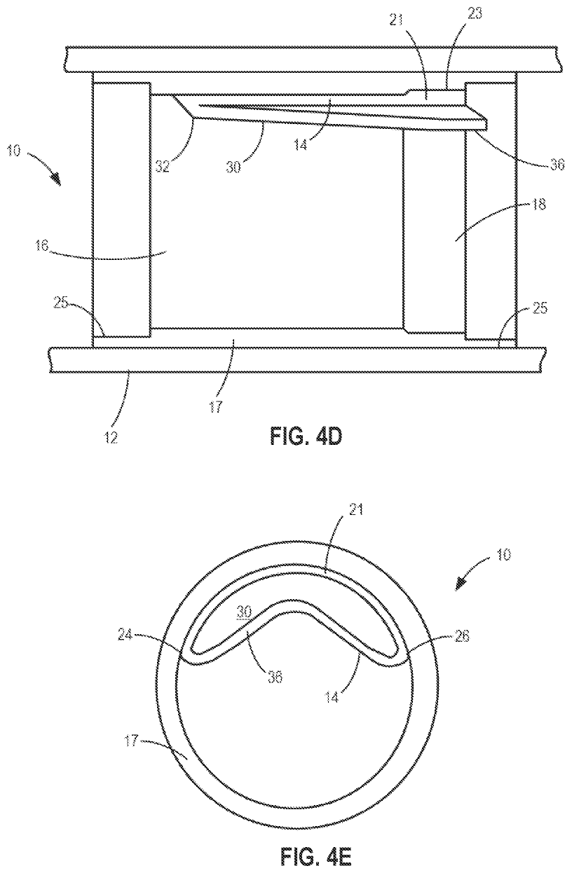

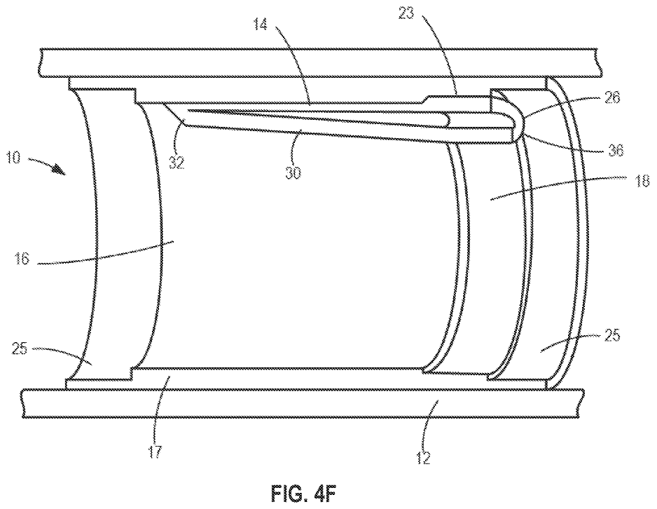

Referring now to FIGS. 4a to 4f, another embodiment of the check valve 10 is shown. In this embodiment, the fluid outlet region 18 is generally tubular instead of including trough 20. The sleeve 14 includes a top wall 21, side walls 24, 26, and bill 36 attached to or integral with the disc 30. The sleeve 14 and wall components thereof may be constructed substantially as described in reference to FIGS. 1a-2d. The connection between the disc 30 and at least a portion of the top wall 21 and side walls 24, 26 is defined by a flexible member 32. The flexible member 32 may be constructed substantially as described in reference to FIGS. 1a-2d.

As noted above, the top wall 21, side walls 24, 26, and bill 36 define the tubular structure of the sleeve 14, which in some embodiments is adapted for connection to a tubular body 17. The top wall 21 of the sleeve 14 may be vulcanized to the tubular body 17, but at least a portion of the sleeve 14, such as at least a portion of the side walls 24, 26 and the bill 36, are not vulcanized to or otherwise connected to the tubular body 17, such that the bill 36 may be deflected toward the top wall 21 responsive to fluid flow and/or pressure. The tubular body 17 may include circumferential or partially circumferential retaining shoulder 23 adapted to receive a corresponding ridge of the top wall 21, side walls 24, 26, and/or bill 36, thereby locating the sleeve 14 in the tubular body 17. An upstream and/or a downstream end of the tubular body 17 may include a clamping shoulder 25 for receiving an internal expanding clamp, or other securing means known in the art, for securing the sleeve 14 to the conduit 12.

FIGS. 4d and 4e show the check valve 10 in an opened position, in which the disc 30 is biased by the flow of effluent toward the top wall 21. The side walls 24, 26 at least partially fold over and the bill 36 separates from the tubular body 17, allowing the effluent to pass from the fluid inlet regions 16 to the fluid outlet region 18.

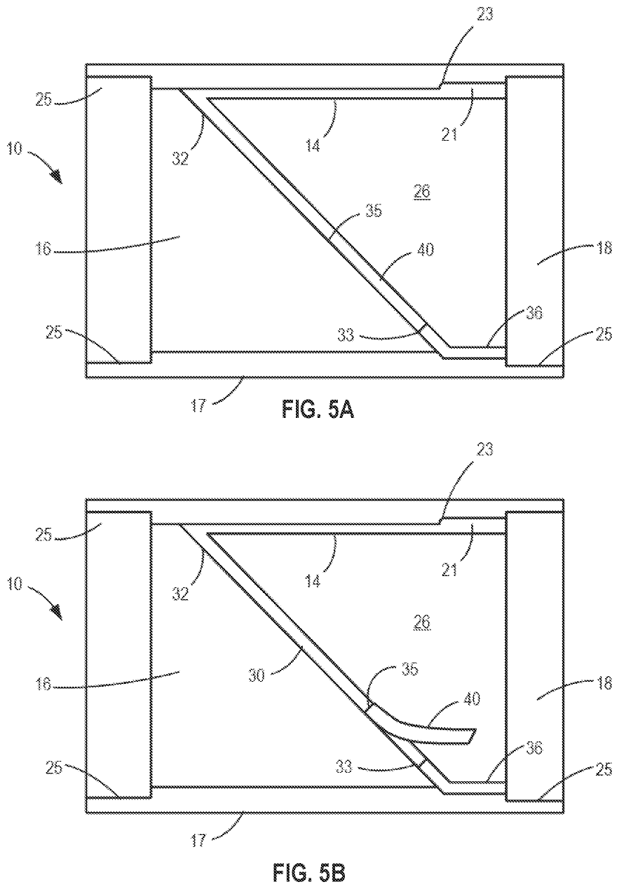

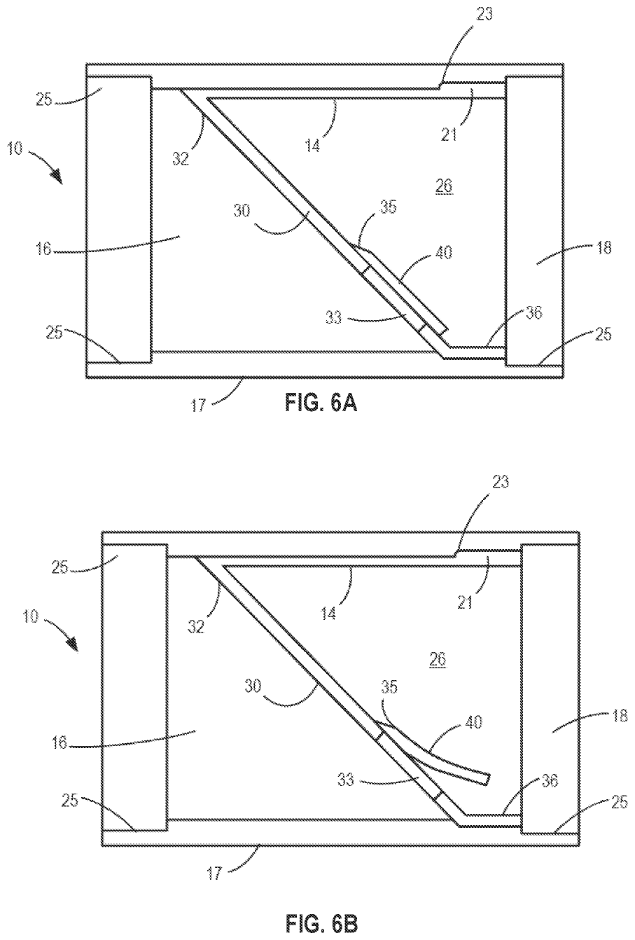

Referring now to FIGS. 5a-6b, the check valve 10 of the present invention may include a flap 40 interactive with an aperture 33 in the disc 30. The flap 40 is disposed in or affixed to the disc 30 via a flexible hinge 35. The flap 40 and flexible hinge 35 may be formed integrally with the disc 30, as shown in FIGS. 5a-5b. Alternatively, as shown in FIGS. 6a-6b, the flap 40 and the flexible hinge 35 may be formed separately from the disc 30 and adhered to the disc 30 via vulcanization or other means known in the art. The flap 40 and/or the flexible hinge 35 may be composed of an elastomeric material or cloth material. For example, the flap 40 and/or the flexible hinge 35 may be comprised of one or more plies of an elastomeric material, or fabric reinforced elastomeric material.

The flap 40 is movable or deflectable between a closed position (shown in FIGS. 5a and 6a) and an opened position (shown in FIGS. 5b and 6b) based on a differential pressure within the valve 10. In a closed position, the flexible hinge 35 biases the flap 40 toward the aperture 33 forming a seal against fluid backflowing through the valve 10 into the fluid inlet region 16. When a sufficient differential pressure exists within the valve 10, upstream effluent forces the flap 40 away from the aperture 33 into the opened position. The effluent may then flow through the aperture 33 until the differential pressure returns to a level below that necessary to open the flap 40. The flap 40 and flexible hinge 35 are designed such that the differential pressure necessary to open the flap 40 is less than the differential pressure necessary to open the bill 36. As such, a small differential pressure insufficient to open the bill 36 may be sufficient to open the flap 40. Thus, effluent may flow through the valve 10 via the flap 40 even in low differential pressure or low flow conditions.

The flap 40 is mechanically obstructed from moving or deflecting in the upstream direction toward the fluid inlet region 16, thereby preventing a negative differential pressure from opening the flap 40. As such, backflow of fluid is prevented. In some embodiments, such as those in which the flap 40 is formed integrally with the disc 30, at least a portion of the disc 30 around a perimeter of the aperture 33 is beveled. That is, the bevel on the disc 30 tapers such that the aperture 33 is larger on the side of the disc 30 adjacent to the fluid outlet region 18, and smaller on the side of the disc adjacent to the fluid inlet region 16. A corresponding portion of a perimeter of the flap 40 may also be beveled to form a cooperating surface with the bevel of the disc 30. The cooperating bevels on the flap 40 and disc 30 prohibit the flap 40 from being forced through the aperture 33 toward the fluid inlet region 16, as at least a portion of the flap 40 is too large to pass through the inlet side of the aperture 33.

In other embodiments, such as those in which the flap 40 is formed separately from the disc 30, the flap 40 may be larger than the aperture 33 such that the flap 40 cannot be forced through the aperture 33 toward the fluid inlet region 16.

Corresponding mating surfaces of the flap 40 and the disc 30 may include or define a sealing structure to further prevent backflow or leaks from the fluid outlet region 18 into the fluid inlet region 16. For example, mating surfaces of the flap 40 and the disc 30 may be constructed of a softer material than the surrounding portions of the flap 40 and the disc 30, such that the mating portions deform against each other to provide a fluid-tight seal between the flap 40 and the disc 30.

Drawings 5a-6b show the flap 40 and flexible hinge 35 utilized in the embodiment of the check valve 10 shown and described with reference to FIGS. 4a-4f. However, it is to be understood that the flap 40 and flexible hinge 35 may be utilized with other embodiments of check valves, including but not limited to the check valves 10 shown and described with reference to FIGS. 1-3.

Whereas particular embodiments of this invention have been described above for purposes of illustration, it will be evident to those skilled in the art that numerous variations of the details of the present invention may be made without departing from the invention. For example, it is to be understood that the present disclosure contemplates that, to the extent possible, one or more features of any embodiment can be combined with one or more features of any other embodiment.

The invention claimed is:

1. A check valve comprising:
(a) a tubular sleeve bounding a longitudinally-extending flow-through passage for fluids, said sleeve having an upstream fluid inlet end region adapted to be affixed to an effluent conduit and a downstream fluid outlet region;
(b) the downstream fluid outlet region of said sleeve being integrally formed with a top wall, a pair of side walls, and a bill, said downstream fluid outlet region of said sleeve providing a flow-through passage for said fluids;
(c) a disc affixed along a first portion of its periphery to a flexible member, said flexible member affixed to and interposed between said disc and at least one of said top wall and said pair of side walls of said sleeve, wherein a second portion of the periphery of said disc opposite said first portion is affixed to said bill of said sleeve, and wherein said disc opens said valve in response to a first positive differential pressure within said valve;
(d) the bill being integrally formed with said side walls of said sleeve, said bill being formed of a flexible material, said bill forming a first opening for discharge of fluid in response to the first positive differential pressure within said valve from said fluid, and said bill forming a seal to prevent backflow of said fluid through said valve when no differential pressure or negative differential pressure is present; and
(e) a flap affixed to said disc via a flexible hinge, said disc defining an aperture forming a second opening for discharge of fluid in response to a second positive differential pressure within said valve from said fluid, wherein said second positive differential pressure is less than said first positive differential pressure, and wherein said flap forms a seal against said aperture to prevent backflow of said fluid through said valve when no differential pressure or negative differential pressure is present.

2. The check valve of claim 1, wherein the flap and the flexible hinge are integrally formed with the disc.

3. The check valve of claim 1, wherein the flap is vulcanized to the disc.

4. The check valve of claim 1, wherein at least one of the disc and the flap include a sealing structure forming a seal between the disc and the flap.

5. The check valve of claim 4, wherein the sealing structure comprises:
(a) a beveled edge on at least a portion of the flap; and
(b) a beveled edge on a portion of the disc corresponding to the beveled edge on the portion of the flap, the beveled edge on the portion of the disc tapering such that the aperture is larger on the side of the disc adjacent to the fluid outlet region and smaller on the side of the disc adjacent to the fluid inlet region, such that the flap is prohibited from passing through the aperture.

6. The check valve of claim 4, wherein said sealing structure comprises a material softer than the material of a surrounding region of at least one of said flap and said disc, the softer material adapted to deform to create a fluid-tight seal.

7. The check valve of claim 3, wherein a perimeter of said flap is larger than a perimeter of said aperture such that said flap is prohibited from passing through said aperture.

8. The check valve of claim 1, wherein said sleeve, said flexible member, said disc and said bill are each formed of one or more plies of an elastomeric material.

9. A check valve assembly comprising:
(a) a check valve according to claim 1; and
(b) a tubular body,
wherein the check valve is at least partially integrally formed within the tubular body.

10. The assembly of claim 9, wherein at least one of an upstream region of the tubular body and a downstream region of the tubular body is affixed to an interior portion of a conduit.

11. The assembly of claim 9, wherein the flap and the flexible hinge are integrally formed with the disc.

12. The assembly of claim 9, wherein the flap is vulcanized to the disc.

13. The assembly of claim 9, wherein at least one of the disc and the flap include a sealing structure forming a seal between the disc and the flap.

14. The assembly of claim 13, wherein the sealing structure comprises:
(a) a beveled edge on at least a portion of the flap; and
(b) a beveled edge on a portion of the disc corresponding to the beveled edge on the portion of the flap, the beveled edge on the portion of the disc tapering such that the aperture is larger on the side of the disc adjacent to the fluid outlet region and smaller on the side of the disc adjacent to the fluid inlet region, such that the flap is prohibited from passing through the aperture.

15. The assembly of claim 13, wherein said sealing structure comprises a material softer than the material of a surrounding region of at least one of said flap and said disc, the softer material adapted to deform to create a fluid-tight seal.

16. The assembly of claim 12, wherein a perimeter of said flap is larger than a perimeter of said aperture such that said flap is prohibited from passing through said aperture.
